(19) United States
(12) Patent Application Publication
(10) Pub. No.: US 2022/0163338 A1
(43) Pub. Date: May 26, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Kengo TOKUCHI, Kanagawa (JP)

(73) Assignee: FUJIFILM Business Innovation Corp., Tokyo (JP)

(21) Appl. No.: 17/331,165

(22) Filed: May 26, 2021

(30) Foreign Application Priority Data
Nov. 20, 2020 (JP) 2020-193756

(51) Int. Cl. G01C 21/34; G06Q 30/02

(52) U.S. Cl. CPC G01C 21/3476; G06Q 30/0273; G06Q 30/0267; G06Q 30/0252; G06Q 30/0201

(57) ABSTRACT

An information processing apparatus includes a processor configured to output guidance information in accordance with the number of objects to be measured that are present at a specific position.

### CROSS-REFERENCE TO RELATED APPLICATIONS

This application is based on and claims priority under 35 USC 119 from Japanese Patent Application No. 2020-193756 filed Nov. 20, 2020.

### BACKGROUND

### (i) Technical Field

The present disclosure relates to an information processing apparatus and a non-transitory computer readable medium.

### (ii) Related Art

Technologies for providing guidance information such as an advertisement are known.

International Publication No. 2019/240295 describes an advertising method that aims to provide a promotional advertisement that is suitable for a desired target.

Japanese Unexamined Patent Application Publication No. 2005-173042 describes a method of displaying an advertisement broadcast from a broadcast station on a display surface of a head mounted display in correspondence with the real space.

### SUMMARY

Aspects of non-limiting embodiments of the present disclosure relate to providing guidance information in consideration of the number of objects to be observed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to output guidance information in accordance with a number of objects to be measured that are present at a specific position.

### BRIEF DESCRIPTION OF THE DRAWINGS

Exemplary embodiments of the present disclosure will be described in detail based on the following figures, wherein:

FIG. 1 is a block diagram illustrating the configuration of an information processing system according to the present exemplary embodiment;

FIG. 2 is a block diagram illustrating the configuration of a server according to the present exemplary embodiment;

FIG. 3 is a block diagram illustrating the configuration of a terminal apparatus according to the present exemplary embodiment;

FIG. 4 illustrates an overview of AR glasses;

FIG. 5 is a flowchart illustrating the flow of a process related to setting of an advertisement service;

FIG. 6 is a flowchart illustrating the flow of a process related to output of advertisement information;

FIG. 7 is a flowchart illustrating the flow of a process related to output of leading information;

FIG. 8 schematically illustrates persons who are present at a certain location;

FIG. 9 schematically illustrates persons who are present at a certain location;

FIG. 10 illustrates a screen;

FIG. 11 illustrates a screen; and

FIG. 12 schematically illustrates a row of objects to be measured.

### DETAILED DESCRIPTION

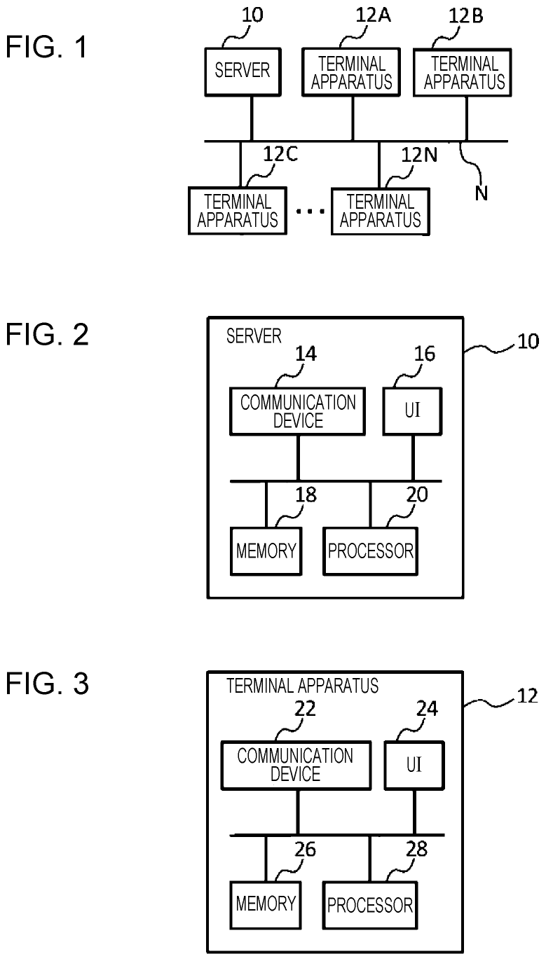

An information processing system according to the present exemplary embodiment will be described with reference to FIG. 1. FIG. 1 illustrates an example of the configuration of the information processing system according to the present exemplary embodiment.

The information processing system according to the present exemplary embodiment includes a server 10 and N (N is an integer of one or more) terminal apparatuses, by way of example. In the example illustrated in FIG. 1, the information processing system according to the present exemplary embodiment includes terminal apparatuses 12A, 12B, 12C, . . . , and 12N. The number of terminal apparatuses illustrated in FIG. 1 is merely exemplary, and it is only necessary that one or a plurality of terminal apparatuses should be included in the information processing system according to the present exemplary embodiment. In the following description, the terminal apparatuses 12A, 12B, 12C, . . . , and 12N will be referred to as “terminal apparatuses 12” in the case where it is not necessary to distinguish the individual terminal apparatuses. The information processing system according to the present exemplary embodiment may include devices other than the server 10 and the terminal apparatuses 12.

The server 10 and the terminal apparatuses 12 have a function to communicate with a different device. The communication may be made through wired communication in which a cable is used, or may be made through wireless communication. That is, the devices may be physically connected to a different device through a cable to transmit and receive information, or may transmit and receive information through wireless communication. Examples of the wireless communication include near-field wireless communication and Wi-Fi (registered trademark). Examples of the near-field wireless communication include Bluetooth (registered trademark), Radio Frequency Identifier (RFID), and Near Field Communication (NFC). The devices may communicate with a different device via a communication path N such as a Local Area Network (LAN) and the Internet, for example.

The server 10 outputs guidance information. The guidance information is information for guiding humans, living things other than humans, objects other than living things, etc. Examples of the guidance information include information (hereinafter referred to as “advertisement information”) that indicates an advertisement, information (hereinafter referred to as “warning information”) that indicates a warning, information for leading humans, living things other than humans, objects other than living things, information that indicates a route, and other information related to guidance. The advertisement publicizes merchandise, services, persons, businesses, and other items for a commercial or non-commercial purpose, for example.

The guidance information is information that indicates guidance using a character string or an image, information that indicates guidance using a sound such as a voice, information that provides guidance using vibration, information that provides guidance using light, information that provides guidance using a signal such as an electric signal, or a combination thereof.

Outputting the guidance information is displaying the guidance information such as a character string or an image on a display, generating the guidance information such as a sound from a speaker, transmitting the guidance information to persons etc. using vibration, generating light from a light source, transmitting the guidance information to persons etc. using a signal such as an electric signal, or a combination thereof. The guidance information may be transmitted to persons etc. as a sound using bone conduction. The concept of outputting the guidance information may include transmitting the guidance information to humans, other living things, objects such as devices, etc. using a different method. For example, the concept of outputting the guidance information may include displaying the guidance information in a virtual space.

Examples of the terminal apparatuses 12 include a personal computer (hereinafter referred to as a “PC”), a tablet PC, a smartphone, a cellular phone, a wearable device, a device that has a function of indicating information through vibration, a device that emits light, a display, a speaker, and a combination thereof. The terminal apparatuses 12 may be apparatuses assumed to be operated by a user, or may be apparatuses installed at a certain location and not assumed to be operated by a user. For example, the terminal apparatuses 12 may be a smartphone or a tablet PC possessed and operated by a user, or may be a display, a speaker, etc. installed at a certain location.

The wearable device is an ear-wearable device to be worn on an ear of an animal (e.g. a human or an animal other than a human), a device to be worn on the head of an animal, a device (e.g. a wristwatch-type device such as a smartwatch) to be worn on a wrist, an arm, or a finger (hereinafter referred to as “wrist etc.”) of an animal, a device to be worn on the neck of an animal, a device to be worn on the body (e.g. chest, abdomen, etc.) of an animal, a device to be worn on a lower limb (e.g. a thigh, a calf, a knee, a foot, an ankle, etc. of a human), a glass-type device, a contact lens-type device, etc.

The ear-wearable device may be an earphone, a hearing aid, an earring-type device, a clip-type device, a device that includes a band or a cable to be wound around an ear, etc., for example. The device to be worn on the head may be a headset that includes a band, a cable, etc. to be wound around the head, for example. The device to be worn on the wrist etc. may be a device that includes a band, a cable, etc. to be wound around the wrist etc., for example. The device to be worn on the other portions may also include a band, a cable, etc.

The wearable device may be a device that uses a technology to enhance the real space or the real environment (e.g. the real space or the real environment perceived by persons). Examples of such a technology include an Augmented Reality (AR) technology and a Mixed Reality (MR) technology. For example, the wearable device may be a device that displays a virtual object (e.g. an image, a character string, etc.) on the real space using the AR technology or the MR technology. Alternatively, the wearable device may be a device that implements Virtual Reality (VR).

For example, the wearable device may be AR glasses, MR glasses, or VR glasses, which are glass-type devices. Alternatively, the wearable device may be a device called “smart glasses”. For example, the wearable device may be a glass-type device that displays information (e.g. an image, a character string, etc.) on a transparent display (e.g. a glass portion of the glasses). The wearable device may be a head mounted display (HMD) that adopts the AR technology, the MR technology, or the VR technology.

The hardware configuration of the server 10 will be described below with reference to FIG. 2. FIG. 2 illustrates an example of the hardware configuration of the server 10.

The server 10 includes a communication device 14, a user interface (UI) 16, a memory 18, and a processor 20, for example.

The communication device 14 is a communication interface that includes a communication chip, a communication circuit, etc., and has a function of transmitting information to a different device and a function of receiving information from a different device. The communication device 14 may have a wireless communication function, or may have a wired communication function. The communication device 14 may communicate with a different device by using near-field wireless communication, or may communicate with a different device via the communication path N, for example.

The UI 16 is a user interface, and includes at least one of a display and an operation device. The display may be a display device such as a liquid crystal display or an electro-luminescence (EL) display. The operation device may be a keyboard, an input key, an operation panel, etc. The UI 16 may be a UI that serves as both the display and the operation device such as a touch screen.

The memory 18 is a device that constitutes one or a plurality of storage areas that store various kinds of information. Examples of the memory 18 include a hard disk drive, various types of memories (e.g. a random access memory (RAM), a dynamic random access memory (DRAM), a read only memory (ROM), etc.), other storage devices (e.g. an optical disk etc.), and a combination thereof. One or a plurality of memories 18 are included in the server 10.

The memory 18 may store the guidance information. As a matter of course, the guidance information may not be stored in the memory 18, and may be stored in the memory 18 and stored in a different device.

The processor 20 is configured to control operation of various portions of the server 10. The processor 20 may include a memory.

The processor 20 is also configured to output the guidance information. For example, the processor 20 outputs the guidance information in accordance with the number of objects to be measured that are present at a specific position.

The concept of the specific position includes a specific location, a specific region or range that has an expanse, and a location etc. determined by an address, a location name, etc.

The concept of the objects to be measured includes living things (e.g. humans, animals other than humans, and plants) and objects other than living things (e.g. devices and objects other than devices).

The method of detecting the number of objects to be measured is not specifically limited, and the number of objects to be measured may be detected using various methods.

For example, in the case where an object to be measured possesses, or has worn thereon, a device that is capable of acquiring position information using a Global Positioning System (GPS) etc., the processor 20 acquires position information on each object to be measured from the device, and specifies the position of the object to be measured. The processor 20 detects the number of objects to be measured that are present at a specific position on the basis of the specified position of each of the objects to be measured. For example, in the case where the object to be measured is a person and the person possesses the terminal apparatus 12 which has a GPS function, the processor 20 specifies the position of the person using the GPS function.

In another example, objects to be measured may be imaged by a camera such as a security camera or a surveillance camera, and the processor 20 may detect the number of objects to be measured that are present at a specific position on the basis of an image generated through the imaging. For example, the specific position is included in the imaging range of the camera, and the processor 20 detects the number of objects to be measured that are present at the specific position on the basis of an image generated through the imaging.

In still another example, in the case where the objects to be measured are living things, the processor 20 may detect the number of the objects to be measured that are present at a specific position on the basis of biological information on the objects to be measured. The biological information may be a body temperature (e.g. information obtained through thermography), a fingerprint, a bioelectric potential, a voice, etc. As a matter of course, other biological information may also be used. For example, voices of objects to be measured that are present at a specific position are collected using a microphone, and the processor 20 detects the number of the objects to be measured that are present at the specific position on the basis of the number, type, volume, etc. of the collected voices. For example, the processor 20 detects the number of humans on the basis of the number of voices of humans, and detects the number of animals on the basis of the number of sounds from animals other than humans.

In the case where the objects to be measured are not living things, the processor 20 may detect the number of the objects to be measured on the basis of sounds generated from the objects to be measured. For example, in the case where the objects to be measured are cars, trains, etc., the processor 20 detects the number of the objects to be measured on the basis of noise etc. generated from the objects to be measured which are cars, trains, etc.

The processor 20 may output the guidance information in accordance with the number of a plurality of types of objects to be measured. For example, in the case where humans and animals other than humans are present at a specific position, the processor 20 may output the guidance information in the case where the total of the number of the humans and the number of the animals other than the humans is equal to or more than a threshold.

The processor 20 may output the guidance information to each of objects to be measured that are present at a specific position. For example, the processor 20 may transmit the guidance information to the terminal apparatuses 12 which are possessed or worn by objects to be measured that are present at a specific position and display the guidance information on a display of the terminal apparatuses 12, generate the guidance information as a voice from a speaker of the terminal apparatuses 12, or cause the terminal apparatuses 12 to vibrate in accordance with the guidance information. In another example, the processor 20 may display the guidance information on a display (e.g. a display that is not possessed or worn by the objects to be measured) installed at a specific position, or may generate the guidance information as a voice (e.g. in-house broadcast) from a speaker toward a specific position. In still another example, the processor 20 may radiate light toward a specific position in accordance with the guidance information.

The processor 20 may output the guidance information to each of objects to be measured that are not present at a specific position. For example, the processor 20 may transmit the guidance information to the terminal apparatuses 12 which are possessed or worn by objects to be measured that are not present at a specific position and display the guidance information on a display of the terminal apparatuses 12, generate the guidance information as a voice from a speaker of the terminal apparatuses 12, or cause the terminal apparatuses 12 to vibrate in accordance with the guidance information. In another example, the processor 20 may display the guidance information on a display installed at a position other than a specific position, or may generate the guidance information as a voice from a speaker toward a position other than a specific position. In still another example, the processor 20 may radiate light toward a position other than a specific position in accordance with the guidance information.

The processor 20 may output the guidance information in accordance with the number of objects to be measured that are present at a specific position at a time determined in advance. For example, the processor 20 outputs the guidance information in accordance with the number of objects to be measured that are present at a specific position in a certain time zone. A plurality of time zones may be set. Alternatively, the processor 20 may output the guidance information in accordance with the number of objects to be measured that have been present at a specific position over a time determined in advance or more.

The processor 20 may output different guidance information in accordance with the number of objects to be measured that are present at a specific position.

The processor 20 may output the guidance information in the case where the number of objects to be measured that are present at a specific position is equal to or more than a threshold. The threshold is a value determined in advance, for example. The threshold may be changed by a manager of the information processing system, a user of a service provided by the information processing system, etc. For example, the threshold may be determined by a user who receives the guidance information. The threshold may be determined for each user.

The guidance information is information provided by a provider of the guidance information, and may be provided on a chargeable basis. In this case, the processor 20 may vary the threshold in accordance with a fee to be paid for the provision of the guidance information. For example, the guidance information may be advertisement information, the provider of the guidance information may be an advertiser, and the fee to be paid for the provision of the guidance information may be an advertisement fee.

For example, a lower threshold is set as the fee (e.g. advertisement fee) is higher. That is, the processor 20 outputs the guidance information, even if the number of objects to be measured that are present at a specific position is smaller, as the fee is higher. A specific example in which the objects to be measured are persons is described. The threshold is 100 persons in the case where the advertisement fee for a period determined in advance (e.g. one week, one month, etc.) is 10,000 yen, 50 persons in the case where the advertisement fee is 100,000 yen, and one person in the case where the advertisement fee is 1,000,000 yen. In the case where the advertisement fee is 10,000 yen, the advertisement information is not output (e.g. an advertisement is not displayed on a display) even if one person is present at the specific position, and the advertisement information is output (e.g. an advertisement is displayed on a display) in the case where 100 persons are present at the specific position.

The processor 20 may output the guidance information in accordance with the number of objects to be measured that are present at a specific position and the viewing field of each of the objects to be measured. The viewing field is a range viewed by an object to be measured such as a person, or a range from which an object to be measured is seeable. The method of detecting a viewing field or a line of sight is not specifically limited, and a viewing field or a line of sight may be detected using various methods. For example, in the case where the object to be measured is a person, the processor 20 may detect the viewing field or the line of sight of the person on the basis of an image generated by imaging the face of the person, or may detect the viewing field or the line of sight of the person on the basis of the direction of the terminal apparatus 12 possessed by the person. For example, in the case where a person wears a device such as AR glasses, the processor 20 may detect the viewing field or the line of sight of the person on the basis of the direction of the device such as AR glasses.

For example, the processor 20 outputs the guidance information in the case where the number of objects to be measured that are present at a specific position is equal to or more than a threshold and the viewing fields of the objects to be measured that are present at the specific position, the number of which is equal to or more than the threshold, are included in the same viewing field. The concept of the viewing fields of the objects to be measured being included in the same viewing field include a case where the viewing fields of the objects to be measured coincide with each other (i.e. a case where the viewing fields of the objects to be measured are the same), a case where the viewing fields of the objects to be measured partially overlap each other with the size of the overlapping range equal to or more than a threshold, etc.

In another example, the processor 20 may output the guidance information in the case where the number of objects to be measured that are present at a specific position is equal to or more than a threshold and the lines of sight of the objects to be measured that are present at the specific position, the number of which is equal to or more than the threshold, are included in the same viewing field.

In still another example, the direction of the object to be measured may be used in place of the viewing field or the line of sight. For example, in the case where the object to be measured is a person, the direction of the face corresponds to the direction of the person as the object to be measured. The processor 20 detects the direction of the face using the method of detecting the viewing field or the line of sight. The processor 20 may output the guidance information in the case where the number of persons who are present at a specific position is equal to or more than a threshold and the directions of the persons (e.g. the directions of their faces) that are present at the specific position, the number of whom is equal to or more than the threshold, are the same direction. The concept of the same direction includes a case where the directions of the persons coincide with each other, a case where the difference among the directions of the persons is included in an allowable range, etc. Also for animals other than humans, the guidance information may be output by detecting the directions of the animals in the same manner.

The processor 20 may output the guidance information in accordance with the viewing field, the line of sight, or the direction of the object to be measured, irrespective of the position of the object to be measured. For example, the processor 20 may output the guidance information in the case where the number of objects to be measured, the viewing fields of which are included in the same viewing field, is equal to or more than a threshold. The objects to be measured, the viewing fields of which are included in the same viewing field, are estimated to have concern for or interest in an object that is present in the same viewing field or a phenomenon, an event, etc. that occurs in the viewing field. The processor 20 outputs the guidance information in the case where the number of objects to be measured that have the same concern is equal to or more than a threshold.

The hardware configuration of the terminal apparatus 12 will be described below with reference to FIG. 3. FIG. 3 illustrates an example of the hardware configuration of the terminal apparatus 12.

The terminal apparatus 12 includes a communication device 22, a user interface (UI) 24, a memory 26, and a processor 28, for example.

The communication device 22 is a communication interface that includes a communication chip, a communication circuit, etc., and has a function of transmitting information to a different device and a function of receiving information transmitted from a different device. The communication device 22 may have a wireless communication function, or may have a wired communication function. The communication device 22 may communicate with a different device by using near-field wireless communication, or may communicate with a different device via the communication path N, for example.

The UI 24 is a user interface, and includes at least one of a display and an operation device. The display may be a display device such as a liquid crystal display or an electro-luminescence (EL) display. The operation device may be a keyboard, an input key, an operation panel, etc. The UI 24 may be a UI that serves as both the display and the operation device such as a touch screen. The UI 24 may include a microphone and a speaker.

The memory 26 is a device that constitutes one or a plurality of storage areas that store various kinds of information. Examples of the memory 26 include a hard disk drive, various types of memories (e.g. a RAM, a DRAM, a ROM, etc.), other storage devices (e.g. an optical disk etc.), and a combination thereof. One or a plurality of memories 26 are included in the terminal apparatus 12.

The processor 28 is configured to control operation of various portions of the terminal apparatus 12. The processor 28 may include a memory.

For example, the processor 28 receives guidance information transmitted from the server 10, and displays the guidance information on the display, generates the guidance information as a voice from a speaker, generates vibration in accordance with the guidance information, or generates light in accordance with the guidance information.

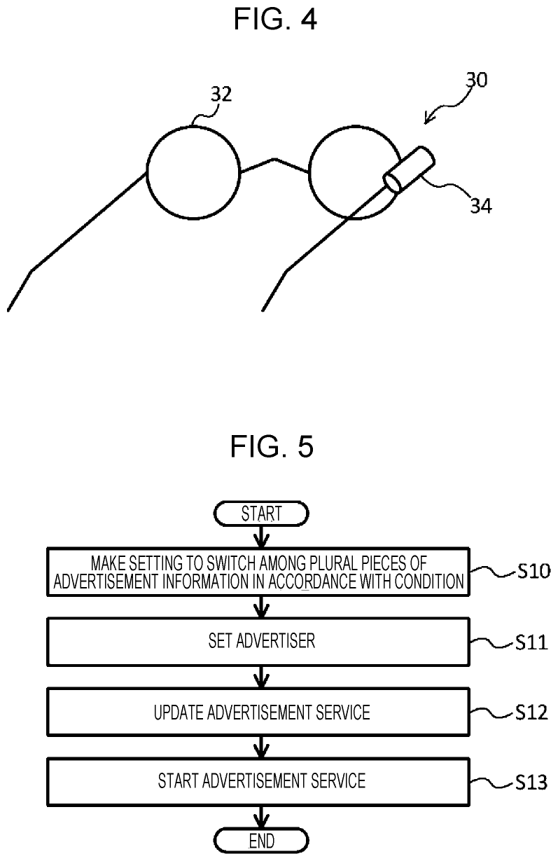

The AR glasses will be described below with reference to FIG. 4. FIG. 4 illustrates an example of the AR glasses. AR glasses 30 are an example of the terminal apparatus 12. The terminal apparatus 12 may be constituted as a combination of the AR glasses 30 and a different device (e.g. a device such as a smartphone or a tablet PC).

The AR glasses 30 have an imaging function and a communication function, for example. The AR glasses 30 include various sensors such as a sensor (e.g. a GPS sensor) that acquires position information on the AR glasses 30 and a gyro sensor that detects the orientation and the posture thereof.

The AR glasses 30 include a glass-type display 32 and a camera 34 that images the real space (e.g. the real space included in the viewing field of a person or the real space which includes the viewing field) ahead of the line of sight of a person who wears the AR glasses 30. The glass-type display 32 may be a see-through display, or may be a non-see-through display.

In the following description, an object that is present in the real space is occasionally referred to as a “real object”. A virtual object is a concept that is contrastive to the real object. Examples of the virtual object include an image, a character string, a figure, and other information. The image may be a still image, a movie, or a combination thereof.

An object is virtually displayed for a real object on the display 32 using the AR technology. Virtually displaying an object for a real object corresponds to displaying a virtual object, which is an example of an image that represents the object, as superimposed on the real space on the screen of the display 32. For example, an image for the right eye and an image for the left eye are generated in consideration of the parallax between the eyes of a person, and displayed on the right and left displays, respectively. When a person sees the real space through the display 32, the virtual object is displayed as superimposed as if the virtual object is actually present in the real space.

The processor 20 may specify the line of sight and the viewing field of an object to be measured (e.g. a person) that wears the AR glasses 30 by analyzing an image generated through imaging by the camera 34, or may specify the line of sight and the viewing field of an object to be measured that wears the AR glasses 30 on the basis of the result of detection by various sensors, such as a gyro sensor, which are provided in the AR glasses 30. The direction of the object to be measured (e.g. the direction of the face) may be specified.

While the AR glasses have been described here, the MR glasses, the VR glasses, the HMD, etc. may be used instead.

An overview of a process according to the present exemplary embodiment will be described below.

A process related to setting of a service provided in accordance with the present exemplary embodiment will be described with reference to FIG. 5. FIG. 5 is a flowchart illustrating the flow of the process. Here, it is assumed that the guidance information is advertisement information, and that an advertisement service to provide the advertisement information is provided, by way of example.

First, setting is made at the server 10 to switch among a plurality of pieces of advertisement information in accordance with a condition determined in advance, even at the same position (S10). Examples of the condition include the number of objects to be measured that are present at the position, or the viewing field of each of the objects to be measured.

Next, an advertiser is set at the server 10 (S11). For example, the advertisement information, an advertisement fee, a fee payment method, the period of advertisement, etc. are set.

The advertisement service is updated in accordance with the above setting (S12), and the advertisement service is started (S13). The processor 20 of the server 10 outputs the advertisement information in accordance with the above condition.

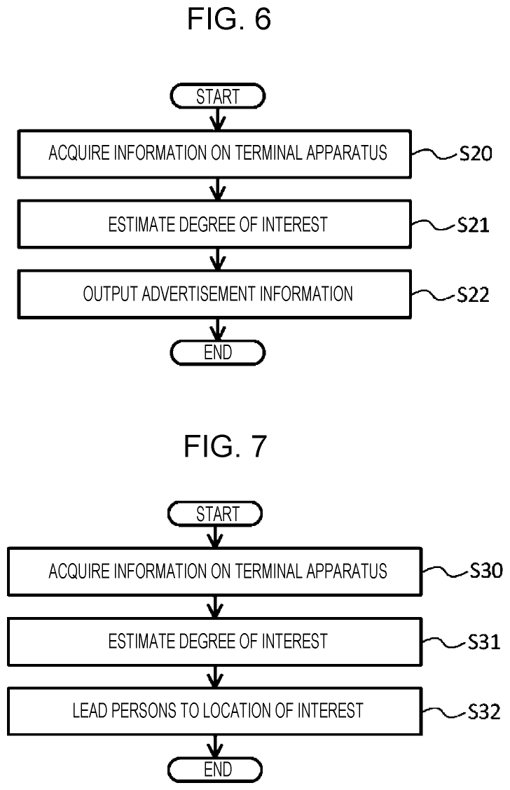

A process related to output of the advertisement information will be described with reference to FIG. 6. FIG. 6 is a flowchart illustrating the flow of the process.

The processor 20 of the server 10 acquires information on the terminal apparatus 12 (S20). For example, the processor 20 acquires information on each terminal apparatus 12 registered in the server 10. Here, by way of example, the object to be measured is a person, and the processor 20 acquires information on the terminal apparatus 12 possessed by each person. Examples of the information on the terminal apparatus 12 include position information on the terminal apparatus 12 and information that indicates the direction of the terminal apparatus 12 (e.g. information that indicates the viewing field or the line of sight of the person, etc.).

The processor 20 estimates the degree of interest of each person on the basis of the information on the terminal apparatus 12 acquired in step S20 (S21). For example, the processor 20 estimates the degree of interest of each person on the basis of the position information on each terminal apparatus 12, information that indicates the viewing field of each person, etc. For example, in the case where the number of persons who are present at a specific position is equal to or more than a threshold, the persons, the number of whom is equal to or more than the threshold, are estimated to have the same concern for or interest in a certain phenomenon, event, etc. In the case where the viewing fields of persons, the number of whom is equal to or more than a threshold, are included in the same viewing field, meanwhile, the persons, the number of whom is equal to or more than the threshold, are estimated to have the same concern for or interest in an object that is in the viewing field or ahead of the line of sight, a phenomenon, an event, etc. that occurs in the viewing field.

The processor 20 outputs the advertisement information in accordance with the degree of interest (S22). For example, the processor 20 outputs the advertisement information to persons who have a high degree of interest. Specifically, in the case where the number of persons who are present at a specific position is equal to or more than a threshold, the persons, the number of whom is equal to or more than the threshold, are estimated to have a high degree of interest (e.g. have a degree of interest that is equal to or more than a threshold) in a certain phenomenon, event, etc. In this case, the processor 20 outputs the advertisement information. For example, the advertisement information is displayed on the display of the terminal apparatus 12 of each person.

A process related to output of leading information will be described with reference to FIG. 7. FIG. 7 is a flowchart illustrating the flow of the process.

The processor 20 of the server 10 acquires information on the terminal apparatus 12 (S30), as in step S20 described above.

In addition, the processor 20 estimates the degree of interest of each person (S31), as in step S21.

The processor 20 leads each person to a location of interest (S32), by outputting leading information for leading each person to the location of interest. For example, in the case where the viewing fields of persons, the number of whom is equal to or more than a threshold, are included in the same viewing field, the persons, the number of whom is equal to or more than the threshold, are estimated to have concern for or interest in an object that is present in the viewing field, or a phenomenon, an event, etc. that occurs in the viewing field. In this case, the processor 20 outputs leading information for leading each person to the object, the phenomenon, the event, etc. For example, the processor 20 outputs leading information for leading each person to an object etc. that is present ahead of the line of sight of the person. The leading information is displayed on the display of the terminal apparatus 12 of each person, for example.

Exemplary embodiments of the present exemplary embodiment will be described below. The processor 20 of the server 10 or the processor 28 of the terminal apparatus 12 may execute a process according to each exemplary embodiment, or the processor 20 and the processor 28 may cooperate with each other to execute a process according to each exemplary embodiment. A part of a certain process may be executed by the processor 20, and the other part of the process may be executed by the processor 28. The server 10, the terminal apparatus 12, or a combination thereof corresponds to an example of the information processing apparatus according to the present exemplary embodiment.

### First Exemplary Embodiment

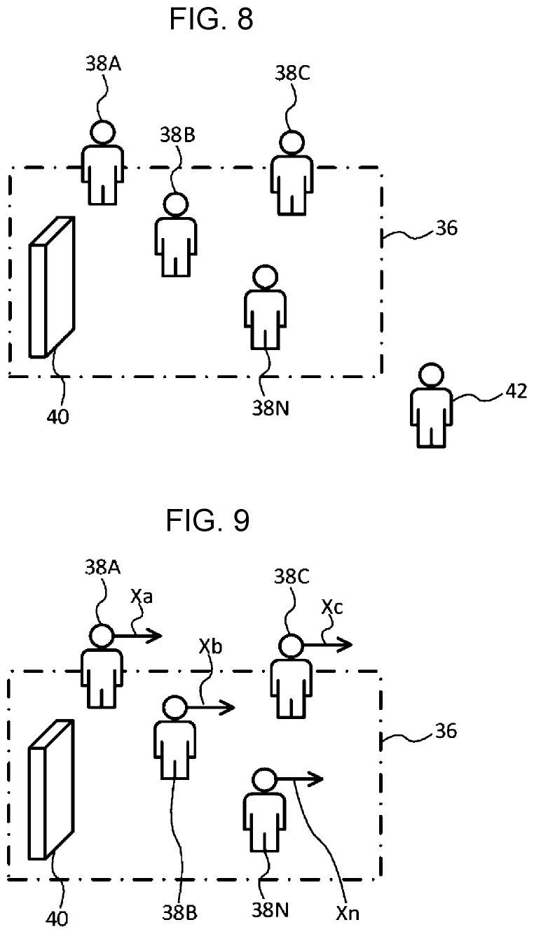

A first exemplary embodiment will be described below with reference to FIG. 8. FIG. 8 schematically illustrates persons who are present at a certain location.

In the example illustrated in FIG. 8, persons 38A, 38B, 38C, . . . , and 38N as objects to be measured are present at a specific position 36 (e.g. a region with an expanse determined in advance). While the objects to be measured are persons here by way of example, the objects to be measured may be living things other than persons or objects. In the following description, the persons 38A, 38B, 38C, . . . , and 38N will be referred to as “persons 38” in the case where it is not necessary to distinguish the individual persons.

The processor 20 of the server 10 detects the number of objects to be measured that are present at the specific position 36. The detection method is not specifically limited as discussed above. In the example illustrated in FIG. 8, the processor 20 detects the number of persons who are present at the specific position 36.

The processor 20 outputs the guidance information in accordance with the number of persons who are present at the specific position 36. For example, the processor 20 outputs the guidance information in the case where the number of persons who have been present at the specific position 36 over a time determined in advance or more is equal to or more than a threshold. The time may be changed by a manager of the information processing system, or may be changed by a person as an object to be measured. As discussed above, the threshold may be changed in accordance with the fee (e.g. advertisement fee) to be paid for the provision of the guidance information.

For example, the processor 20 may transmit the guidance information to the terminal apparatuses 12 which are possessed or worn by the persons 38 who are present at the specific position 36 and display the guidance information on a display of the terminal apparatuses 12, generate the guidance information as a voice from a speaker of the terminal apparatuses 12, or cause the terminal apparatuses 12 to vibrate in accordance with the guidance information. For example, in the case where the terminal apparatus 12 is AR glasses, the processor 20 causes the AR glasses to display the guidance information. In the case where the AR glasses have a bone conduction function, the guidance information may be transmitted to the person 38 through bone conduction. Address information on the terminal apparatus 12 and account information on each person are registered in advance in the server 10, and the processor 20 transmits the guidance information to each terminal apparatus 12 using such registered information.

Examples of the guidance information include advertisement information. For example, the processor 20 outputs the same advertisement information to each of the persons 38 who are present at the specific position 36. The persons 38 who are present at the specific position are estimated to have concern for or interest in the same phenomenon, the same event, etc. In the case where the number of persons 38 who are present at the specific position 36 becomes equal to or more than a threshold, the processor 20 estimates that the persons 38 have higher or concentrated concern for or interest in a certain phenomenon, event, etc., and outputs the advertisement information to each of the persons 38.

In the case where the number of persons 38 who have been present at the specific position 36 over a time determined in advance or more is equal to or more than a threshold, the persons 38 are estimated to have much higher concern or interest, and the processor 20 may output the advertisement information to each of the persons 38.

The processor 20 may output advertisement information that matches the specific position 36. For example, the processor 20 may output advertisement information on a store that is present at or around the specific position 36, advertisement information on an event that occurs at or around the specific position 36, etc.

The processor 20 may output advertisement information that matches the attribute of each person 38. Examples of the attribute of the person 38 include the sex, age, occupation, company that the person 38 works for, department to which the person 38 belongs, line of work, hobbies, tastes, height, weight, blood type, hometown, address, qualifications, and contact (e.g. telephone number, e-mail address, social networking service (SNS) account, etc.). As a matter of course, the attribute of the person 38 may include other attributes. Information that indicates the attribute of each person 38 is stored in advance in the server 10. For example, the processor 20 transmits advertisement information that matches the hobbies of a person 38 to the terminal apparatus 12 of the person 38.

The processor 20 may output the advertisement information to a display that is present at the specific position 36, and cause the display to display the advertisement information. In the example illustrated in FIG. 8, a display 40 is installed at the specific position 36, and the advertisement information is displayed on the display 40. In this manner, the advertisement information may not be output from the terminal apparatus 12 possessed or worn by each person 38, and digital signage may be implemented using a different display, projector, etc.

The processor 20 may generate the advertisement information as a voice using in-house broadcast etc.

Information other than the advertisement information may be output as the guidance information. For example, the guidance information may be hazard information that informs the persons 38 who are present at the specific position 36 of a hazard, warning information that warns the persons 38, etc. For example, in the case where a hazardous phenomenon such as a natural disaster, an incidence, or an accident occurs at or around the specific position 36, the processor 20 may transmit information (e.g. hazard information or warning information) that indicates the occurrence of the natural disaster, the incidence, or the accident at or around the specific position 36 to the terminal apparatuses 12 of the persons 38, the display 40, etc. Consequently, the information is displayed on the display of the terminal apparatuses 12 etc., or generated as a voice from a speaker.

The processor 20 may transmit, to the terminal apparatuses 12 of the persons 38, the display 40, etc., information that is necessary to avoid the above hazard, information that indicates an evacuation route, information that guides or leads the persons 38 to the evacuation route, etc. Consequently, the information is displayed on the display of the terminal apparatuses 12 etc., or generated as a voice from a speaker.

In the case where the distance between the persons 38 who are present at the specific position 36 is less than a threshold, the processor 20 may transmit, to the terminal apparatuses 12 of the persons 38, the distance between whom is less than the threshold, information for keeping the distance equal to or more than the threshold. For example, in the case where the persons 38 are densely located, information that instructs the persons 38 to keep the distance therebetween equal to or more than the threshold is transmitted to the terminal apparatus 12 of each of the persons 38.

In the case where the terminal apparatus 12 is AR glasses, the advertisement information, hazard information, warning information, leading information which indicates an evaluation route, etc. are displayed on the AR glasses.

In the case where the person 38 wears an ear-wearable device, the above information is transmitted to the person 38 through the ear-wearable device. The information may be transmitted to the person 38 as a voice, or may be transmitted to the person 38 using bone conduction or vibration.

In the case where the person 38 attempts to capture an image using a camera provided in the terminal apparatus 12, the processor 20 of the server 10 may display the guidance information on the display of the terminal apparatus 12. For example, the processor 20 may display the guidance information on the display of the terminal apparatus 12 when the person 38 activates the camera of the terminal apparatus 12, and hide the guidance information when the camera captures an image (e.g. when the person 38 presses a capture button).

The processor 20 of the server 10 may output the guidance information to an object to be measured that is not present at the specific position 36. In the example illustrated in FIG. 8, a person 42 is an object to be measured that is not present at the specific position 36. That is, the person 42 is an object to be measured that is present outside the range of the specific position 36. In this case, the processor 20 transmits the guidance information to the terminal apparatus 12 possessed or worn by the person 42. For example, the person 42 is a person (e.g. a surveillant, a manager, etc.) who surveils or manages the specific position 36, and the guidance information is provided to the person 42. For example, in the case where a hazardous phenomenon occurs, it is conceivable that hazard information etc. is provided to the person 42, and that the person 42 leads the persons 38 who are present at the specific position 36 for evacuation on the basis of the hazard information etc.

The processor 20 of the server 10 may output different guidance information in accordance with the number of persons 38 who are present at the specific position 36. The processor 20 may output guidance information varied stepwise in accordance with the number of persons 38 who are present at the specific position 36. The processor 20 may vary the number of pieces of guidance information to be output in accordance with the number of persons 38 who are present at the specific position 36. For example, the processor 20 may output an increased number of pieces of guidance information as the number of persons 38 who are present at the specific position 36 is larger. A specific example is described. The processor 20 outputs one piece of advertisement information to each person 38 in the case where the number of persons 38 who are present at the specific position 36 is equal to or more than a first threshold and less than a second threshold (the second threshold is larger than the first threshold). The processor 20 outputs two pieces of advertisement information (e.g. two pieces of advertisement information with different contents) to each person 38 in the case where the number of persons 38 who are present at the specific position 36 is equal to or more than the second threshold.

The number of persons 38 as objects to be measured may be the number of persons who use the terminal apparatus 12. The terminal apparatus 12 to be used may be an apparatus possessed or worn by the person 38 who uses the terminal apparatus 12, may be an apparatus that is placed but not possessed or worn by the person 38 (e.g. an apparatus on display placed in a store etc.), or may be an apparatus possessed or worn by a person other than the person 38 who uses the terminal apparatus 12. The concept of using the terminal apparatus 12 includes turning on the terminal apparatus 12, operating the terminal apparatus 12, causing an application to operate on the terminal apparatus 12, etc., for example. The processor 20 of the server 10 determines, through communication with the terminal apparatus 12, whether or not the terminal apparatus 12 is used. For example, in the case where the terminal apparatus 12 is turned off, the processor 20 of the server 10 excludes the person 38 who possesses or wears the terminal apparatus 12 from the objects to be measured, and does not count the person 38. That is, the processor 20 counts the number of persons 38 who use the terminal apparatuses 12.

The processor 20 of the server 10 may determine a region with an expanse determined in advance and in which persons 38, the number of whom is equal to or more than a threshold, are present as the specific position 36, and output the guidance information.

### Second Exemplary Embodiment

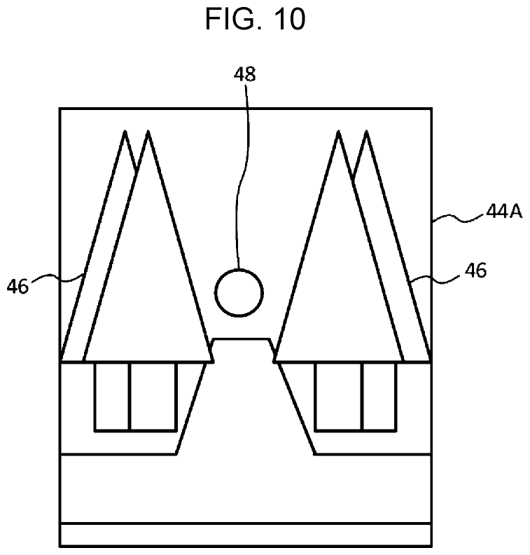

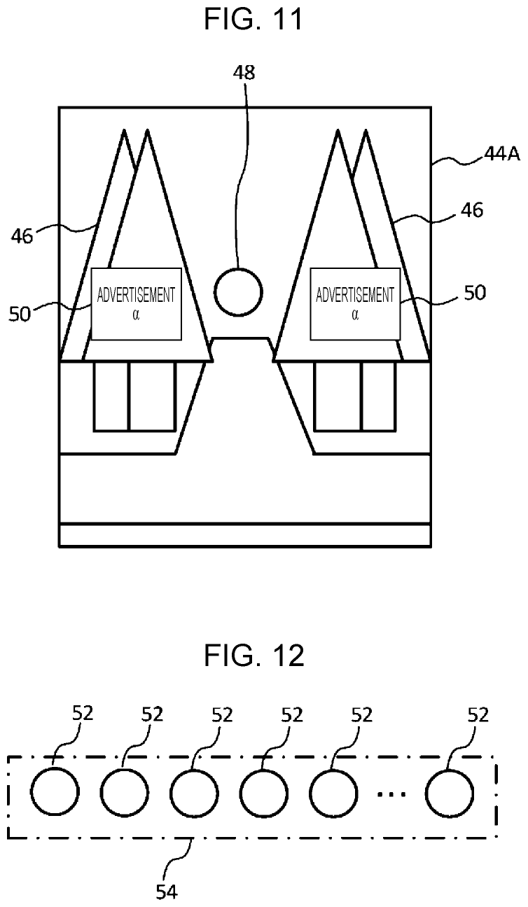

A second exemplary embodiment will be described below with reference to FIGS. 9 to 11. FIG. 9 schematically illustrates persons who are present at a certain location. FIGS. 10 and 11 illustrate a screen.

Also in the second exemplary embodiment, as in the first exemplary embodiment, the persons 38 as objects to be measured are present at the specific position 36 as illustrated in FIG. 9.

In the second exemplary embodiment, the processor 20 of the server 10 outputs the guidance information in accordance with the number of persons 38 who are present at the specific position 36 and the viewing field of each of the persons 38. The processor 20 may output the guidance information in accordance with the number of persons 38 and the line of sight of each of the persons 38. In another example, the processor 20 may output the guidance information in accordance with the number of persons 38 and the direction (e.g. the direction of the face) of each of the persons 38. As discussed above, the method of detecting the viewing field, the line of sight, and the direction is not specifically limited.

In FIG. 9, the line of sight of each of the persons 38 is indicated. For example, an arrow Xa indicates the line of sight of the person 38A, an arrow Xb indicates the line of sight of the person 38B, an arrow Xc indicates the line of sight of the person 38C, and an arrow Xn indicates the line of sight of the person 38N. The processor 20 of the server 10 detects such lines of sight and viewing fields.

For example, the processor 20 of the server 10 outputs the guidance information in the case where the number of persons 38 who are present at the specific position 36 is equal to or more than a threshold and the viewing fields of the persons 38 who are present at the specific position 36, the number of whom is equal to or more than the threshold, are included in the same viewing field. Here, by way of example, advertisement information is output.

The persons 38, the viewing fields of whom are included in the same viewing field, are estimated to have concern for or interest in the same object that is present in the viewing field or the same phenomenon, event, etc. that occurs in the viewing field. In the case where the viewing fields of the persons 38 who are present at the specific position 36, the number of whom is equal to or more than a threshold, are included in the same viewing field, the processor 20 estimates that the persons 38 have higher or concentrated concern for or interest in the same object that is present in the viewing field or the same phenomenon, event, etc. that occurs in the viewing field, and outputs the advertisement information to each of the persons 38.

In the case where the viewing fields of the persons 38 who have been present at the specific position 36 over a time determined in advance or more, the number of whom is equal to or more than a threshold, are included in the same viewing field, the persons 38 are estimated to have much higher concern or interest, and the processor 20 may output the advertisement information to each of the persons 38.

A display example of the advertisement information will be described below with reference to FIGS. 10 and 11. FIGS. 10 and 11 illustrate a screen 44A. The screen 44A is the screen of a display of the terminal apparatus 12A possessed or worn by the person 38A. In the case where the terminal apparatus 12A is the AR glasses 30 illustrated in FIG. 4, the screen 44A is the screen of the display 32 of the AR glasses 30. In the case where the terminal apparatus 12A is a smartphone or a tablet PC provided with a camera, an object, a scene, etc. captured by the camera is displayed on the screen 44A.

FIG. 10 illustrates trees 46 and a moon 48. In the case where the terminal apparatus 12A is the AR glasses 30, the person 38A is able to see the trees 46 and the moon 48, which are real objects, through the display 32 of the AR glasses 30. That is, the trees 46 and the moon 48 are included in the viewing field of the person 38A, and the person 38A is able to see the trees 46 and the moon 48 through the display 32 of the AR glasses 30. In the case where the terminal apparatus 12A is a smartphone or a tablet PC, an image of the trees 46 and the moon 48 captured by the camera is displayed on the screen 44A. In the example illustrated in FIG. 10, the moon 48 is seeable as disposed between the tree 46 and the tree 46.

For example, in the case where the persons 38 who are present at the specific position 36, the number of whom is equal to or more than a threshold, see the trees 46 and the moon 48 from the specific position 36, that is, the viewing fields of the persons 38, the number of whom is equal to or more than a threshold, are included in the same viewing field including the trees 46 and the moon 48, the processor 20 estimates that the lines of sight are concentrated on the viewing field and the persons 38 have higher or concentrated concern for or interest in the viewing field, and outputs the advertisement information to each of the persons 38.

For example, the advertisement information is displayed on the display of the terminal apparatus 12 of each person 38. FIG. 11 illustrates a display example. As illustrated in FIG. 11, advertisement information 50 that indicates an advertisement a is displayed on the screen 44A.

In the case where the terminal apparatus 12A is the AR glasses 30, the advertisement information 50 as a virtual object is displayed as superimposed on objects (e.g. the trees 46 etc.) that are present in the real space. In the case where the terminal apparatus 12A is a smartphone or a tablet PC, the advertisement information 50 is displayed as superimposed on images of the trees 46.

For example, the processor 20 of the server 10 may specify the direction on which the lines of sight of the persons 38 are concentrated, by analyzing the lines of sight of the persons 38, and display the advertisement information 50 off the direction. In the example illustrated in FIG. 11, it is estimated that the persons 38 see the moon 48, and that the lines of sight of the persons 38 are concentrated on the moon 48. In this case, the processor 20 displays the advertisement information 50 off the position of the moon 48 on the screen 44A. For example, the processor 20 displays the advertisement information 50 as superimposed on the real trees 46 on the AR glasses 30, or displays the advertisement information 50 as superposed on images of the trees 46.

For example, in the case where the person 38A wears the AR glasses 30, which are an example of the terminal apparatus 12A, and sees the trees 46 and the moon 48, the processor 20 of the server 10 specifies the line of sight and the viewing field of the person 38A on the basis of the direction of the AR glasses 30, and displays the advertisement information 50 as superimposed on the real trees 46 on the AR glasses 30. In the case where the AR glasses 30 have an imaging function, the advertisement information 50 may be hidden when imaging is performed.

In another example, in the case where the person 38A activates a camera of a smartphone, which is an example of the terminal apparatus 12A, and directs the lens of the camera to the trees 46 and the moon 48, the processor 20 of the server 10 specifies the line of sight and the viewing field of the person 38A on the basis of the direction of the smartphone, and displays the advertisement information 50 as superposed on images of the trees 46 on the smartphone. The advertisement information 50 may be hidden in the case where the person 38A provides an instruction to capture by pressing a capture button of the camera etc.

The advertisement information 50 is also displayed on the terminal apparatus 12 which is possessed or worn by a different person 38 other than the person 38A, as in the example illustrated in FIG. 11.

In the examples illustrated in FIGS. 10 and 11, the guidance information (e.g. the advertisement information 50) is displayed. However, the guidance information may be transmitted to the persons 38 using a voice, or may be transmitted to the persons 38 using vibration or light.

The processor 20 of the server 10 may output leading information for leading the persons 38 to the direction on which the lines of sight are concentrated, as an example of the guidance information. The example illustrated in FIGS. 10 and 11 is described. The leading information is information for leading the persons 38 to a position from which the trees 46 and the moon 48 are seeable. The leading information may be information that indicates the leading destination, or may be information that indicates a map. The leading information may be displayed on the display of the terminal apparatus 12, may be transmitted to the persons 38 using a voice, or may be transmitted to the persons 38 using vibration or light. For example, the leading information may be projected onto the floor, the ground surface, etc. of a location at which the persons 38 are present using light, or may be transmitted to the persons 38 through in-house broadcast.

The processor 20 of the server 10 may output the guidance information in accordance with the viewing field, the line of sight, or the direction of the persons 38, irrespective of the position of the persons 38. The example illustrated in FIGS. 10 and 11 is described. In the case where the number of persons 38, the viewing fields of whom are included in the same viewing field, is equal to or more than a threshold, the processor 20 outputs the advertisement information 50 to each of the persons 38. Consequently, the advertisement information 50 is displayed as illustrated in FIG. 11. In another example, in the case where the lines of sight of the persons 38, the number of whom is equal to or more than a threshold, are in the same direction, the processor 20 may output the advertisement information 50 to each of the persons 38. For example, in the case where the lines of sight of the persons 38, the number of whom is equal to or more than a threshold, are directed to the same object (e.g. the moon 48), the processor 20 outputs the advertisement information 50 to each of the persons 38.

### Third Exemplary Embodiment

A third exemplary embodiment will be described below. In the third exemplary embodiment, the guidance information is output on the basis of history information or statistical information.

For example, the processor 20 of the server 10 may output the guidance information on the basis of history information on the number of objects to be measured that were present at a specific position in the past. Examples of the history information include information that indicates the number of objects to be measured that were present at a specific position in each time zone in the past. For example, in the case where the number of persons 38 who were present at the specific position 36 in a certain time band in the past was equal to or more than a threshold, the processor 20 outputs the guidance information, irrespective of whether or not the number of persons 38 who are present at the specific position 36 at the present time is equal to or more than the threshold. The guidance information may be transmitted to the terminal apparatuses 12 of the persons 38 who are present at the specific position 36 at the present time, may be transmitted to the terminal apparatus 12 of the person 42 who is not present at the specific position 36, or may be transmitted to the display 40 etc. which is installed at the specific position 36, for example.

The processor 20 may output the guidance information on the basis of the above history information in the case where no persons 38 that are present at the specific position 36 at the present time are detected. For example, the processor 20 outputs the guidance information on the basis of the history information in the case where position information on the persons 38 as objects to be measured or information that indicates the viewing fields of the persons 38 is not acquired in real time, in the case where the frequency of occurrence of a detection error is high, etc.

### Fourth Exemplary Embodiment

A fourth exemplary embodiment will be described below. In the fourth exemplary embodiment, the processor 20 of the server 10 outputs different guidance information in accordance with the environment of a region including a specific position. Examples of the environment include the weather, the communication environment, the status of congestion, etc.

The guidance information is advertisement information, for example. In the case where it is rainy in a region including the specific position 36, persons are gathered indoor, and therefore it is estimated that a higher advertising effect is obtained indoor than outdoor. In the case where the specific position 36 is indoor, the processor 20 outputs advertisement information from an advertiser with a higher advertisement fee to the persons 38 who are present at the specific position 36 in priority to advertisement information from an advertiser with a lower advertisement fee. For example, the processor 20 outputs advertisement information from an advertiser with a higher advertisement fee more conspicuously than advertisement information from an advertiser with a lower advertisement fee, outputs only advertisement information from an advertiser with a higher advertisement fee but does not output advertisement information from an advertiser with a lower advertisement fee, or outputs advertisement information from an advertiser with a higher advertisement fee for a longer time (e.g. time for which the advertisement information is displayed) than advertisement information from an advertiser with a lower advertisement fee. Examples of the conspicuous display include displaying the advertisement information in a larger size and applying special decoration to the advertisement information. The processor 20 may output guidance information that introduces an umbrella shop.

Besides, the processor 20 may vary the guidance information on the basis of information posted on an SNS. For example, the processor 20 may estimate the environment of a region including a specific position on the basis of information posted on an SNS, and output guidance information that matches the estimation result.

### Fifth Exemplary Embodiment

A fifth exemplary embodiment will be described below. In the fifth exemplary embodiment, the processor 20 of the server 10 outputs the guidance information in the case where a plurality of objects to be measured form a specific region that has a specific shape.

The fifth exemplary embodiment will be described in detail below with reference to FIG. 12. FIG. 12 schematically illustrates a row of objects to be measured. Here, by way of example, the objects to be measured are persons. FIG. 12 illustrates the heads of persons 52 as seen from above. A plurality of persons 52 are arranged in one row to form a region 54 which has a linear shape. The linear shape corresponds to an example of the specific shape. The region 54 corresponds to an example of the specific region. The region 54 also corresponds to an example of the specific position.

For example, in the case where the persons 52, the number of whom is equal to or more than a threshold, are arranged in one row to form the region 54, the processor 20 of the server 10 outputs the advertisement information to each of the persons 52. For example, the processor 20 outputs guidance information that matches the location at which the region 54 is formed, or guidance information that matches the environment of the location, to each of the persons 52.

A specific example is described. In the case where the location at which the region 54 is formed is a taxi stand, the processor 20 outputs advertisement information that indicates an advertisement for a taxi to each of the persons 52. Consequently, the advertisement information is displayed on the display of the terminal apparatus 12 of each of the persons 52, for example. In another example, the processor 20 may output guidance information that guides the person 52 to a different taxi stand, leading information that leads the person 52 to a different taxi stand, etc. to each of the persons 52. Consequently, the advertisement information, the leading information, etc. is displayed on the display of the terminal apparatus 12 of each of the persons 52, for example. The persons 52 may go to the different taxi stand in accordance with the guidance or leading information. The persons 52 who form a row are estimated to be persons waiting for a taxi, and information that is useful to such persons is provided. The guidance information and the leading information may be output to persons other than the persons 52 who form a row (e.g. persons who do not form a row but that are present around the row). This allows the persons who do not form a row to head for the different taxi stand, rather than forming a row themselves.

Another specific example is described. In the case where the location at which the region 54 is formed is a platform at a station, a ticket gate at a station, etc., the processor 20 may output advertisement information related to trains to each of the persons 52. For example, in the case where it is detected that trains are delayed, the processor 20 outputs guidance information that provides guidance of different transportations to the persons 52, detour information that indicates a detour route, etc. to each of the persons 52. Consequently, the guidance information, the detour information, etc. is displayed on the display of the terminal apparatus 12 of each of the persons 52, for example. The person 52 may use the different transportation or use the detour route in accordance with the guidance. The persons 52 who form a row are estimated to be persons waiting for a train, and information that is useful to such persons is provided. The guidance information and the detour information may be output to persons other than the persons 52 who form a row (e.g. persons who do not form a row but that are present around the station). This allows the persons who do not form a row to use the different transportation or the detour route, rather than forming a row themselves.

Still another specific example is described. For example, in the case where the objects to be measured are cars and the cars, the number of which is equal to or more than a threshold, form a row, the processor 20 may estimate that there is a traffic jam, and transmit information for avoiding the traffic jam (e.g. information that indicates a detour route) or information about the traffic jam (e.g. news of the traffic jam etc.) to the terminal apparatuses 12 which are provided on the cars or the terminal apparatuses 12 of drivers of the cars. The information for avoiding the traffic jam or the information about the traffic jam may be transmitted to the terminal apparatuses 12 of cars that do not form in a row or the terminal apparatuses 12 of drivers of such cars. This gives the drivers an opportunity to avoid the traffic jam beforehand.

The processor 20 of the server 10 may output the guidance information in consideration of the viewing field or the line of sight of each of the persons 52. For example, in the case where the persons 52, the number of whom is equal to or more than a threshold, form a row and the viewing fields of the persons 52, the number of whom is equal to or more than the threshold, are included in the same viewing field, the processor 20 may output the guidance information to each of the persons 52. In this case, the persons 52 are estimated to have concern for or interest in an object that is present in the same viewing field or a phenomenon, an event, etc. that occurs in the same viewing field, and the processor 20 outputs the guidance information to the persons 52 under such estimation.

### Sixth Exemplary Embodiment

A sixth exemplary embodiment will be described below.

In the sixth exemplary embodiment, the processor 20 of the server 10 outputs the guidance information in accordance with the degree of interest of the user of a certain terminal apparatus 12 and the degree of interest of the user of a different terminal apparatus 12. The users of the terminal apparatuses 12 are an example of the objects to be measured.

For example, the processor 20 estimates the degree of interest of users in a certain phenomenon, event, etc. on the basis of the viewing fields of the users. As the viewing fields of more users are included in the same viewing field, the users are estimated to have a higher degree of interest in an object that is present in the same viewing field or a phenomenon, an event, etc. that occurs in the viewing field. For example, in the case where the number of users, the viewing fields of whom are included in the same viewing field, is equal to or more than a threshold, the users are estimated to have a high degree of interest in an object that is present in the same viewing field or a phenomenon, an event, etc. that occurs in the viewing field. In this case, the processor 20 outputs the guidance information to each of the users. For example, the advertisement information 50 illustrated in FIG. 11 is transmitted to the terminal apparatuses 12 of the users etc., and displayed on the display, generated as a voice, or transmitted to the user as vibration.

In this manner, the guidance information such as the advertisement information is provided to a plurality of users estimated to have the same concern or interest in consideration of not only concern or interest of the users themselves but also concern or interest of other users. For example, while the advertisement information is not provided in the case where only one user sees in a certain direction, the advertisement information is provided to a plurality of users who see in the same direction in the case where the number of such users is equal to or more than a threshold.

In another example, the processor 20 may estimate the degree of interest of the users on the basis of the positions and the viewing fields of the users, and output the guidance information. For example, in the case where the users, the number of whom is equal to or more than a threshold, are present at a specific position and the viewing fields of the users, the number of whom is equal to or more than the threshold, are included in the same viewing field, the users are estimated to have a high degree of interest in an object that is present in the viewing field or a phenomenon, an event, etc. that occurs in the viewing field. In this case, the processor 20 outputs the guidance information to each of the users. For example, the advertisement information 50 illustrated in FIG. 11 is transmitted to the terminal apparatus 12 etc. of each of the users.

A plurality of the first to sixth exemplary embodiments discussed above may be combined with each other.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing apparatus comprising:
a processor; and
a camera,
wherein the processor is configured to:
receive an output from the camera, the camera creating the output by detecting a line of sight for each of a plurality of users present at a specific position; and
output guidance information when a number of the plurality of users having a same line of sight as detected by the camera is above a predetermined threshold,
wherein the processor is configured to only output the guidance information in a case where the number of the plurality of users having the same line of sight as detected by the camera is above the predetermined threshold.

2. The information processing apparatus according to claim 1,
wherein the processor is configured to output the guidance information to each of the plurality of users are present at the specific position.

3. The information processing apparatus according to claim 1,
wherein the processor is configured to output the guidance information to a user that is not present at the specific position.

4. The information processing apparatus according to claim 1,
wherein the processor is configured to output the guidance information at a time determined in advance.

5. The information processing apparatus according to claim 2,
wherein the processor is configured to output the guidance information at a time determined in advance.

6. The information processing apparatus according to claim 3,
wherein the processor is configured to output the guidance information at a time determined in advance.

7. The information processing apparatus according to claim 1,
wherein the processor is configured to vary the guidance information in accordance with the number of the plurality of users having the same line of sight.

8. The information processing apparatus according to claim 2,
wherein the processor is configured to vary the guidance information in accordance with the number of the plurality of users having the same line of sight.

9. The information processing apparatus according to claim 3,
wherein the processor is configured to vary the guidance information in accordance with the number of the plurality of users having the same line of sight.

10. The information processing apparatus according to claim 4,
wherein the processor is configured to vary the guidance information in accordance with the number of the plurality of users having the same line of sight.

11. The information processing apparatus according to claim 5,
wherein the processor is configured to vary the guidance information in accordance with the number of the plurality of users having the same line of sight.

12. (canceled)

13. The information processing apparatus according to claim 1,
wherein the guidance information is information provided by a provider of the guidance information,
the guidance information is provided on a chargeable basis, and
the processor is configured to vary the threshold in accordance with a fee to be paid by the provider for provision of the guidance information.

14. (canceled)

15. The information processing apparatus according to claim 1,
wherein the processor is configured to output the guidance information on a basis of history information on the number of the plurality of users having the same line of sight that were previously present at the specific position.

16. The information processing apparatus according to claim 15,
wherein the processor is configured to output the guidance information on a basis of the history information in a case where no users having the same line of sight are detected.

17. The information processing apparatus according to claim 1,
wherein the processor is configured to vary the guidance information in accordance with an environment of a region including the specific position.

18. The information processing apparatus according to claim 1,
wherein the processor is configured to output the guidance information in a case where a plurality of objects to be measured form a specific region that has a specific shape.

19. The information processing apparatus according to claim 1,
the plurality of users are users that use a terminal apparatus.

20. A non-transitory computer readable medium storing a program causing a computer to execute a process comprising:
receiving an output from a camera, the camera creating the output by detecting a line of sight for each of a plurality of users present at a specific position; and
outputting guidance information when a number of the plurality of users having a same line of sight as detected by the camera is above a predetermined threshold,
wherein outputting only outputs the guidance information in a case where the number of the plurality of users having the same line of sight as detected by the camera is above the predetermined threshold.
